(19) United States
(12) Patent Application Publication
(10) Pub. No.: US 2016/0054061 A1
(43) Pub. Date: Feb. 25, 2016

(54) COMBUSTION DEVICE

(71) Applicant: Josef KEUSCHNIGG, Kirchberg (AT)

(72) Inventors: JOSEF KEUSCHNIGG, Kirchberg (AT); JOSEF KEUSCHNIGG, JR., Nitscha (AT)

(73) Assignee: Josef KEUSCHNIGG, Kirchberg (AT)

(21) Appl. No.: 14/783,377

(22) PCT Filed: Mar. 25, 2014
(86) PCT No.: PCT/AT2014/000050

§ 371 Date: Oct. 8, 2015

(30) Foreign Application Priority Data
Apr. 10, 2013 (AT) A 280/2013

(51) Int. Cl. F27B 7/20; F27B 7/00; F27B 7/34

(52) U.S. Cl. CPC F27B 7/2016; F27B 7/34; F27B 7/00

(57) ABSTRACT

A combustion device includes a combustion chamber having an exhaust gas opening. The combustion chamber has a first region having a plurality of circular-segment-shaped cross-sections, which are parallel to each other and each have a circle centre point. A connection of the circle centre points lies substantially on an axis. A gas supply line is connected to the combustion chamber in such a way that a discharge point is formed, that the combustion chamber has a mixing region in the region of the discharge point for mixing gas supplied via the gas supply line with gas rotating in the combustion chamber, and that the discharge point is arranged on a bottom side of the combustion chamber in an operating position, wherein gas supplied via the gas supply line flows against the first region tangentially from below.

The invention relates to a combustion device according to the preamble of claim 1.

A combustion device is an apparatus for combusting burning material and comprises a combustion chamber in which the burning material is combusted. A large number of different burning materials are known in this respect, e.g. solid, liquid and gaseous burning materials, which can be combusted in respectively formed combustion devices.

It is disadvantageous in known combustion devices that the use of waste as burning material such as shredded plastic material or wood chips instead of the use of high-value burning materials such as natural gas or heating oil proves to be problematic. Waste materials as burning materials can be very inhomogeneous with respect to their composition or shape, which is why an only partial combustion may occur. Waste needs to be prepared for use as burning material, e.g. comminuted, or the combustion section must be provided with a respective length.

It is therefore the object of the invention to provide a combustion device of the type mentioned above with which the aforementioned disadvantages can be avoided and which can also be operated very well with a highly inhomogeneous burning material.

This is achieved in accordance with the invention by the features of claim 1. This leads to the advantage that as a result of the special shape of the combustion device and especially the combustion chamber a variable dwell time of the burning material occurs in the case of an inhomogeneous burning material such as shredded plastic material or wood chips, wherein it can be ensured that the burning material remains in the combustion chamber until complete combustion has nearly been achieved. In this case, the combustion chamber is formed similar to a cyclone, wherein as yet non-combusted portions of the burning material are recirculated by the gas flow to a side wall of the burning chamber and are kept away from the exhaust gas opening. The burning material can only be carried by the gas flow to the exhaust gas opening when the burning material has been sufficiently combusted and falls beneath a predeterminable size. As a result of the orifice arranged on the bottom side and the flow which is directed upwardly, heavy parts of the burning material are also repeatedly introduced into the combustion process so that reliable combustion can be ensured. The combustion device can thus also be operated with highly inhomogeneous burning material, wherein the combustion device remains compact and simple in its configuration and shows high efficiency.

The invention further relates to a system for producing cement clinker from raw meal according to the preamble of claim 14.

In a system for the production of cement clinker, so-called raw meal is calcined in a multistage process and burned into cement clinker. Such a system may comprise a raw meal preheater for preheating the raw meal for example, wherein the raw meal preheater is connected to a rotary kiln. In order to optimise the output of the rotary kiln, which is an especially complex part of the system that requires a high level of maintenance, a precalciner burning device is provided which precalcines the raw meal before the introduction into the rotary kiln.

The invention further relates to a method for operating a combustion device according to the preamble of claim 15.

It is therefore the further object of the invention to provide a method of the kind mentioned above with which the aforementioned disadvantages can be avoided and with which a combustion device can preferably be operated with inhomogeneous burning material.

This is achieved in accordance with the invention by the features of claim it

Advantages can thus be achieved which are analogous to the advantages of the combustion device.

The dependent claims relate to further advantageous embodiments of the invention.

Express reference is hereby made to the wording of the claims, as a result of which the claims are inserted at this point into the description by way of reference and shall apply as being literally reproduced.

The invention will be explained below in closer detail by reference to the enclosed drawings which merely show preferred embodiments by way of example, wherein:

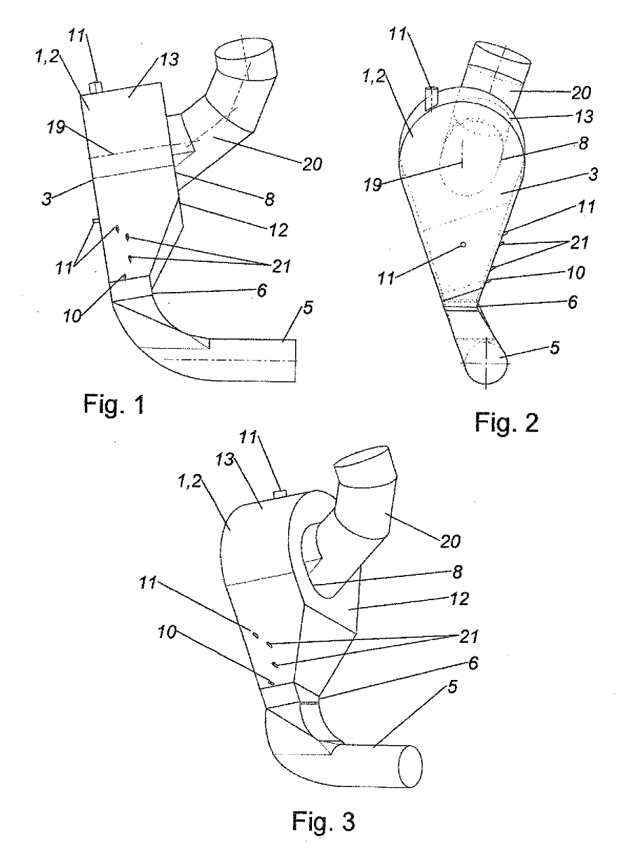

FIG. 1 shows a preferred embodiment of a combustion device in a front view;

FIG. 2 shows of the preferred embodiment of a combustion device in a side view;

FIG. 3 shows the preferred embodiment of a combustion device in an axonometric view;

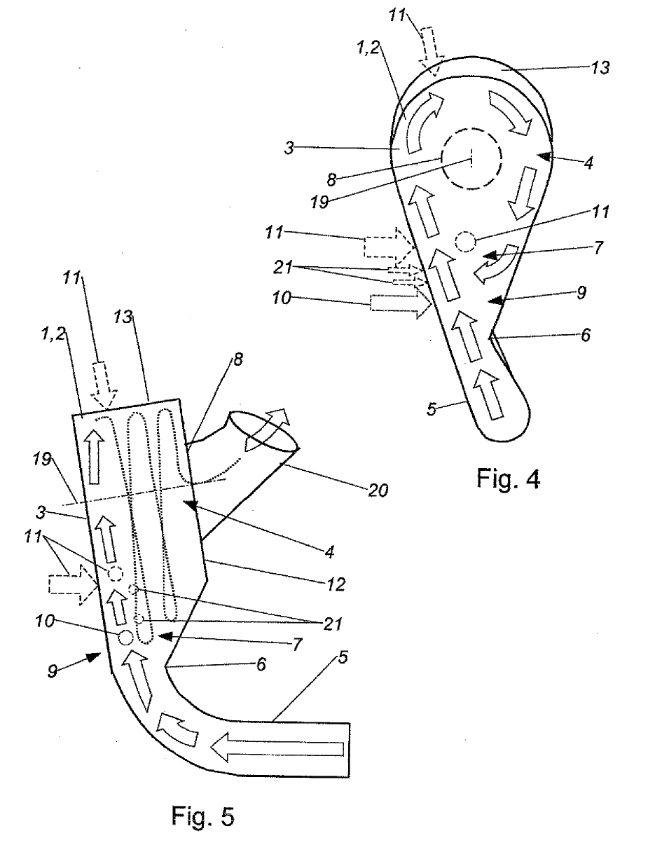

FIG. 4 shows the preferred embodiment of a combustion device in a side view as a schematic diagram;

FIG. 5 shows the preferred embodiment of a combustion device in a front view as a schematic diagram;

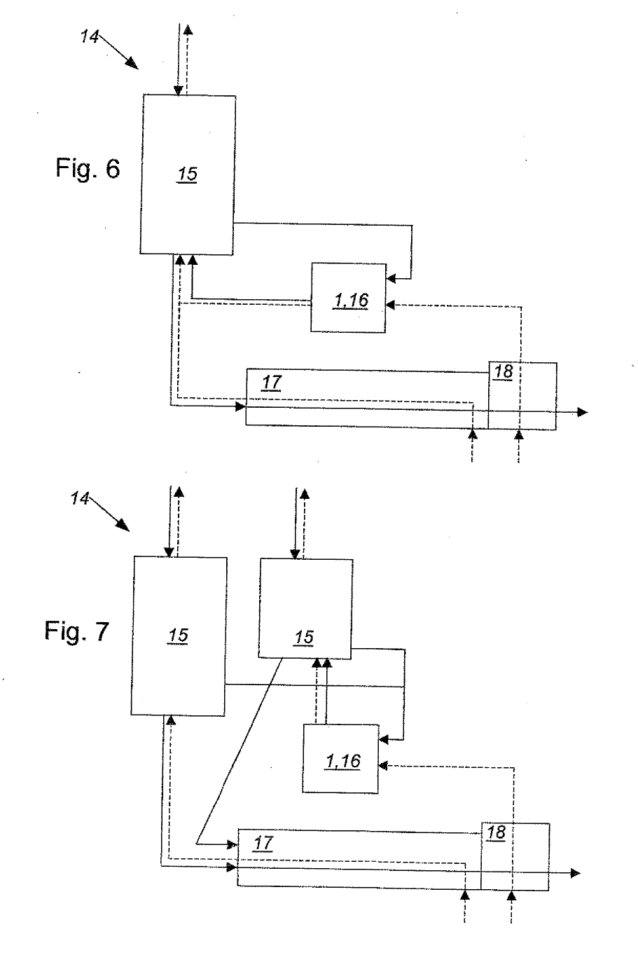

FIG. 6 shows a first preferred embodiment of the system for producing cement clinker as a schematic diagram, and

FIG. 7 shows a second preferred embodiment of a system for producing cement clinker as a schematic diagram.

FIGS. 1 to 5 show a preferred embodiment of a combustion device 1, wherein a combustion chamber 2 of the combustion device 1 comprises an exhaust gas opening 8. In this connection, the combustion device 1 is a mixing and feeding device for the controlled combustion of an especially solid burning material with an oxygen-containing gas such as combustion air. The combustion of the burning material substantially occurs in the combustion chamber 2.

It is provided that the combustion chamber 2 comprises a first region 4, the first region 4 has a plurality of circular-segment-shaped cross-sections, which are parallel to each other and each have a circular centre point, wherein a connection of the circle centre points lies substantially on an axis 19, a gas supply line 5 is connected to the combustion chamber 2 in such a way that an orifice 6 is formed, the combustion chamber 2 has a mixing region 7 in the region of the orifice 6 for thorough mixing of gas supplied via the gas supply line 5 with gas rotating in the combustion chamber 2, and the orifice 6 is arranged on a bottom side of the combustion chamber 2 in an operating position, wherein gas supplied via the gas supply line 5 flows against the first region 4 tangentially from below.

By arranging the orifice 6 on the bottom side of the combustion cylinder 2, heavy parts of the burning material will automatically drop to the orifice 6 under the influence of gravity and are reliably supplied to the combustion process again by the gas flow directed from bottom to top without said parts being able to attach to the bottom side of the combustion chamber 2. Reliable combustion even of heavy components of an inhomogeneous burning material is thus reliably achieved.

The combustion chamber 2 can especially be arranged similar to a cyclone, wherein a gas flow can partly be deflected in the first region 4 around the axis 19 and can be returned to the mixing region 7 again. The first region can also be regarded as a deflection region of the gas flow. The tangential flow into the first region 4 from below means especially an inflow substantially transversely to the axis 19 and along a side wall 13 of the combustion chamber 2, wherein the inflow of the gas flow is directed in the operating position substantially upwardly, i.e. against gravity. A portion of the burning material with large spatial expansion, i.e. insufficiently combusted burning material, will circulate as in a cyclone on a side wall 13 of the combustion chamber 2 and can only escape in the case of sufficient combustion through the exhaust gas opening 8 from the combustion chamber 2.

The operating position is the position of the combustion device 1 in this case which is provided for the operation of the combustion device 1, e.g. as a part of a system 14 for producing cement clinker. The orifice can furthermore be arranged on the lowermost region of the combustion chamber 2.

It can be provided in an especially preferred manner that in the operating position the axis 19 encloses an angle of 0° to 40°, especially 0° to 30°, in relation to a horizontal plane. The axis 19 can therefore be substantially horizontal, wherein an inclination in relation to the horizontal plane of up to 40°, especially up to 30°, can be provided.

It can further be provided that the orifice 6 is arranged in such a way that an intended outflow direction of the gas from the orifice 6 has an angle 5° to 40°, especially 10 to 30°, in relation to the perpendicular.

It can further be provided in an especially preferred manner that in the operating position the orifice is arranged substantially beneath the axis 19.

The first region 4 can be formed in an especially preferred manner in form of a truncated-cone segment, especially in form of a cylinder segment. In the case of a first region 4 formed in the manner of a cylinder segment, the cross-sections are of substantially similar size. In this case, the axis 19, which is substantially formed as the connection of the circular centre points of the various cross-sections, can be the rotational axis of the truncated cone or cylinder whose form of the segment is comprised by the first region 4.

It can especially be provided in this case that the side wall 13 is formed in the first region 4 as part of a jacket surface of a rotational body such as a cone or a cylinder, and the axis 19 extends substantially along the rotational axis of said rotational body.

It is provided in a method for operating a combustion device 1 with a combustion chamber 2 that a gas flow flows into the combustion chamber 2 from below through an orifice 6 of a gas supply line 5 arranged on a bottom side of the combustion chamber 2, the gas flow that flows in from the gas supply line 5 is mixed with a gas rotating in the combustion chamber 2 in a mixing region 7 arranged in the region of the orifice 6, the gas flow flows tangentially against a first region 4 of the combustion chamber 2, wherein the first region 4 comprises a plurality of circular-segment-shaped cross-sections, which are parallel to each other and each have a circular centre point, wherein a connection of the circular centre points substantially lies on an axis 19, the gas flow is deflected in the first region 4 about the axis 19, and the gas flow is discharged again via an exhaust gas opening 8. It can especially be provided that an especially solid burning material is entrained by the gas flow, and the dwell time of a piece of the burning material is determined by the size of the piece of the burning material. The gas can especially contain oxygen, and especially preferably comprises at least 20% of oxygen. Furthermore, air can especially be used as a gas.

It can be provided according to the preferred embodiment in FIGS. 1 to 5 that the combustion chamber 2 comprises in the region of the orifice 6 of the gas supply line 5 a second region 9 with V-shaped cross-section, wherein the second region 9 is tangentially adjacent to the first region 4. The fact that the second region 9 is tangentially adjacent to the first region 4 preferably means that the side wall 13 is formed in a kink-free manner in the transitional region from the first region 4 to the second region 9, so that a gas flow can be formed which extends along the side wall 13. The mixing region 7 can especially be part of the second region 9. The combustion chamber 2 preferably has a drop-shaped cross-section. It can especially be provided that the second region 9 tapers towards the orifice 6. A reliable supply of heavy parts of the burning material to the orifice 6 can be achieved by the shape of the second region 9. Furthermore, thorough mixing in the second region 9 between newly entering gas and gas circulating in the combustion chamber can thus be achieved.

It can especially be provided in this case that at least one further gas supply line 21 opens into the combustion chamber 2, especially in the second region 9. Additional gas which can be branched off from the gas supply line 5 for example can be introduced into the combustion chamber in order to optimise the combustion process and the resulting efficiency by feeding oxygen thereto. According to the preferred embodiment, it can be provided for example that the further gas supply line 21 opens into the side wall 13.

It can further be provided that a recirculation line branches off from the gas discharge line 20, which opens into the gas supply line 5 and/or the further gas supply line 21, wherein a portion of the gas flowing from the exhaust gas opening 8 can be conducted as recirculation gas back into the combustion chamber 2.

According to the illustrated preferred embodiment, the gas supply line 5, in particular immediately in front of the orifice 6, may comprise a bend. The gas supply line 5 can thus advantageously be supplied horizontally at first and an upwardly directed gas flow can still be produced.

It can be provided alternatively that the gas supply line 5 is formed in a straight manner.

It can further especially be provided that the circular-segment-shaped cross-sections of the first region 4 are larger than a semicircle. A closed circumferential orbit of the gas flow can be achieved very well by interaction of the first region 4 and the second region 9.

It is provided in an especially preferred manner that the exhaust gas opening is arranged spaced from the side wall 13. It can thus be prevented that heavy parts of the burning material, which dwell in the side wall 13 as a result of centrifugal forces, can exit through the exhaust gas opening 8.

It can further preferably be provided that the axis 19 intersects the exhaust gas opening 8. This reliably prevents the exit of excessively heavy parts of the burning material through the exhaust gas opening 8 because the heavy parts of the burning material are arranged closer to the side wall 13.

It is further provided in an especially preferred manner that a feeding device 10 for the burning material is arranged in the second region 9. The feeding device 10 for the burning material is used for introducing a burning material into the combustion chamber and can especially comprise an opening in the region of the orifice 6 of the gas supply line 5, through which opening the burning material can be introduced into the combustion chamber 2.

It can be provided in an especially preferred manner that burning material is supplied to the gas flow by means of the feeding device 10 for the burning material.

In particular, the feeding device 10 for the burning material can be formed for introducing a solid pourable burning material, especially a burning material which is inhomogeneous with respect to its size.

It can alternatively be provided that the burning material is introduced together with the gas flow via the gas supply line 5 to the combustion chamber 2.

It can further be provided that waste products with inhomogeneous piece sizes are used as the burning material. The burning material can comprise wood chips for example, and/or a pourable compound of shredded plastic waste made of disposable plastic bottles for example.

It can further be provided that the combustion chamber 2 comprises a feeding device 11 for a tempering medium. The feeding device 11 for the tempering medium is used for introducing a tempering medium, which tempering medium absorbs the thermal energy generated in the combustion device 1, and/or slows down the combustion speed of the burning material. The feeding device 11 for the tempering medium can especially comprise an opening in the region of the orifice 6 of the gas supply line 5, through which opening the tempering medium can be introduced into the combustion chamber 2.

It can be provided in this case that the tempering medium is supplied to the gas flow by means of the feeding device 11 for the tempering medium, and that the tempering medium flows off via the exhaust gas opening 8 again. It can especially be provided that a solid and pourable material is used as a tempering medium which extracts thermal energy from the gas flow in the combustion chamber 2. Poorly flammable gases such as low-oxygen process gases can further be used as a tempering medium.

It can be provided in an especially preferred way that the combustion chamber 2 comprises a first wall 3, and the circular-segment-shaped cross-sections of the first region 4 are arranged substantially parallel to the first wall 3. Good tangential inflow can thus be achieved, wherein a substantially constant flow velocity can be achieved in the first region.

It can be provided in an especially preferred way that the first wall 3 is flat and that the circular-segment-shaped cross-sections are parallel to the first wall. It can further be provided that the axis 19 stands normally to the first wall 3.

The first wall 3 can be formed alternatively in an uneven manner, e.g. conical or curved.

It can further be provided that the orifice 6 is arranged adjacent to the first wall 3. As indicated in FIG. 5, initial combustion can thus occur especially in the region of the first wall 3, wherein a long dwell time of the burning material in the combustion chamber 2 can be achieved.

It can further be provided that the exhaust gas opening is arranged in the region of a second wall 12 situated opposite of the first wall 3. A long dwell time of the burning material in the combustion chamber 2 can thus be achieved.

The second wall 12 can especially be parallel to the first wall 3. It can further be provided that the side wall 13 connects the first wall 3 to the second wall 12, wherein the side wall 13 can especially be normal to the first wall 3 in the first region 4.

According to an embodiment (not shown) it can be provided alternatively that the second wall 12 is inclined in relation to the axis 19 in such a way that the combustion chamber 2 tapers in the first region 4 with increasing distance from the orifice 6.

It can be provided in an especially preferred manner that the first wall 3 is inclined in the operating position in relation to the perpendicular by an angle 5° to 30°, especially 5° to 15°, in such a way that at least a part of the combustion chamber 2 is arranged above the first wall 3. In particular, the axis 19 can enclose an angle of 5° to 40°, especially 10° to 30°, in relation to the horizontal plane. It can be achieved that larger and heavier parts of the burning material drop through gravity to the first wall 3 and are not extracted by suction to the exhaust gas opening 8.

The feeding device 11 for the tempering medium can especially be arranged at several positions. The position of the used feeding device 11 for the tempering medium can be selected on the basis of the composition of the burning material and the tempering medium.

According to the preferred embodiment, two or more feeding devices 11 for the tempering medium can be provided for example. A feeding device 11 for the tempering medium can be arranged for example on the side wall 13 in the mixing region 7. Furthermore, a feeding device 11 for the tempering medium can be arranged on the side wall 13 in the first region 4 for example. It can further be provided that the feeding device 11 for the tempering medium is arranged on the first wall 3 in the mixing region. In this case, the temperature of the gas is differently high in the different regions, e.g. the temperature of the gas in the mixing region 7 is still low, whereas it is higher in the first region 4. The effect of the tempering medium and the combustion process can thus additionally be controlled.

It can especially be provided according to an embodiment (not shown) that the feeding device 10 for the burning material is arranged closer to the first wall 3 than the feeding device 11 for the tempering medium. The burning material introduced into the gas flow can be corn busted at first without obstructions and can be provided with the tempering medium only when reaching a predeterminable temperature.

It can further be provided that a cross-section of the burning chamber 2 changes starting from the first wall 3.

It can be provided in an especially preferred manner that a cross-section of the burning chamber 2 tapers starting from the first wall 3. Larger pieces of the burning material are kept away from the second wall 12 at first and are combusted to a predeterminable size before they reach the region of the exhaust gas opening 8.

It can especially be provided according to an embodiment (not shown) that the exhaust gas opening 8 comprises a collar reaching into the combustion chamber 2. It can thus be prevented that burning material deposited on the second wall 12 is guided over the first wall 3 and is sucked into the exhaust gas opening 8.

It can further be provided that a gas discharge line 20 is connected to the combustion chamber 2 at the exhaust gas opening 8. The gas discharge line 20 can especially be formed as a further combustion section in which the parts of the burning material exiting from the exhaust gas opening 8 can combust further. Since the parts of the burning material entering the gas discharge line 20 are preferably unable to exceed a predeterminable size as a result of the shape of the combustion chamber 2, the length of the combustion section can be kept short, e.g. 10 m to 30 m.

It can further be provided that a further feeding device 11 for the tempering medium is arranged in the region of the exhaust gas opening 8. A further tempering medium can be introduced into the gas discharge line 20 and can be heated homogeneously by mixing and/or heat transfer with the gas or the tempering medium entering from the exhaust gas opening.

The combustion device 1 is especially suitable for a system 14 for producing cement clinker from raw meal with a raw meal preheater 15 comprising at least one cyclone stage for heating the raw meal, a precalciner burning device 16, a rotary kiln 17 and a clinker cooler 18. The raw meal is calcined and burned for producing the cement clinker. The combustion device 1 is arranged in an especially preferred way in the intended operating position.

FIGS. 6 and 7 schematically show preferred embodiments of such a system 14, wherein the solid arrows represent the progression of the raw meal or the cement clinker and the dot-dashed arrows represent the gas flow.

The raw meal preheater 15 is used for preheating the raw meal before it reaches the rotary kiln 17. For this purpose, process gas emerging from the rotary kiln 17 can be conducted to the raw meal preheater 15. The raw meal preheater 15 can comprise several cyclones which are connected to each other in the manner of cascades and in which good heat transfer can occur.

The rotary kiln 17 comprises a rotating tube in which different regions can especially be provided, e.g. for burning or calcining the raw meal.

The heat of the finished cement clinker can be recuperated especially by a clinker cooler 18 arranged downstream of the rotary kiln 17.

The precalciner burning device 16 can precalcine at least portions of the raw meal prior to introduction into the rotary kiln 17.

It can be provided in an especially preferred way that the precalciner burning device 16 is formed as the combustion device 1 as described above. The raw meal can be used as a tempering medium for the combustion device 1, wherein it is precalcined by action of the heat. It can further be prevented by the shape of the combustion device 1 that insufficiently combusted burning material, e.g. pieces of waste materials, reach the raw meal and contaminate the same. Carbon monoxide pollution can be kept at a low level by the optimised combustion process.

The raw meal preheater 15 can especially be connected in this case to the feeding device 10 of the combustion device 1 for the tempering medium, wherein preheated raw meal is used as the tempering medium.

The rotary kiln 17 can be connected to a clinker cooler 18 in order to cool the cement clinker produced from the raw meal. It can especially be provided that the gas supply line 5 leads from the clinker cooler 18 to the combustion device 1. The heat obtained from the clinker cooler 18 is usually used for heating the gas flow, especially the combustion air.

It can further be provided that the exhaust gas opening 8 is connected to the raw meal preheater 15. In this case, the precalcined raw meal can be separated from the raw meal preheater 15 and introduced into the rotary kiln 17, wherein the gas flow heated by the combustion device 1 can further be used for preheating the raw meal in the raw meal preheater 15.

In accordance with FIG. 6, it can be provided in an especially preferred way that the last stage of the raw meal preheater 15 is connected to the precalciner burning device 16 and also the rotary kiln 17. The combustion device 1 can thus be arranged in a compact way.

It can alternatively be provided that the raw meal preheater 15 is merely connected to the precalciner burning device 16 on the output side. The entire raw meal can substantially be precalcined by the precalciner burning device 16.

In accordance with FIG. 7, two raw meal preheaters 15 can preferably be provided, wherein both raw meal preheaters 15 are connected to the feeding device 11 or the tempering medium, wherein the exhaust gas opening opens only into one raw meal preheater 15.

1.-17. (canceled)

18. A combustion device, comprising:
a combustion chamber having an exhaust gas opening, said combustion chamber being configured to have a first region formed as a deflecting region of a gas flow and having a plurality of circular-segment-shaped cross-sections in parallel relationship, each circular-segment-shaped cross-section having a circular centre point, with a connection of the circle centre points lying substantially on an axis, wherein a side wall of the combustion chamber is formed in the first region as part of a jacket surface of a rotational body which defines a rotational axis, said axis extending substantially along of the rotational axis of the rotational body;
a gas supply line connected to the combustion chamber such as to form orifice arranged on a bottom side of the combustion chamber in an operating position, with gas supplied via the gas supply line flowing against the first region tangentially from below and transversely to the axis,
said combustion chamber having a mixing region in a region of the orifice for thorough mixing of gas supplied via the gas supply line with gas rotating in the combustion chamber,
said combustion chamber including in a region of the orifice of the gas supply line a second region with V-shaped cross-section tapering towards the orifice, with the mixing region being part of the second region, said second region being arranged tangentially adjacent to the first region so that a tangential flow against the first region is formed along the side wall.

19. The combustion device of claim 18, wherein the axis encloses in the operating position an angle of 0° to 40° in relation to a horizontal plane.

20. The combustion device of claim 18, wherein, the axis encloses in the operating position an angle of 0° to 30° in relation to a horizontal plane.

21. The combustion device of claim 18, wherein the axis intersects the exhaust gas opening.

22. The combustion device of claim 18, wherein the combustion chamber comprises a first wall, said circular-segment-shaped cross-sections of the first region being arranged substantially parallel to the first wall.

23. The combustion device of claim 22, wherein the orifice is arranged adjacent to the first wall.

24. The combustion device of claim 22, wherein the exhaust gas opening is arranged in the region of a second wall opposite the first wall.

25. The combustion device of claim 18, further comprising a feeding device configured to supply a burning material and arranged in the second region.

26. The combustion device of claim 18, wherein the combustion chamber comprises a feeding device for a tempering medium.

27. The combustion device of claim 22, further comprising a feeding device configured to supply a burning material and arranged in the second region, said combustion chamber comprising a feeding device for a tempering medium wherein the feeding device for the burning material is arranged closer to the first wall than the feeding device for the tempering medium.

28. The combustion device of claim 18, wherein the exhaust gas opening comprises a collar reaching into the combustion chamber

29. The combustion device of claim 18, wherein at least one further gas supply line opens into the combustion chamber.

30. A system for producing cement clinker from raw meal, said system comprising:
a raw meal preheater having at least one cyclone stage for heating raw meal;
a precalciner burning device configured to precalcine at least a portion of the raw meal, said precalciner burning device being constructed as a combustion device as set forth in claim 18;
a rotary kiln arranged downstream of the precalciner burning device; and
a clinker cooler arranged downstream of the rotary kiln.

31. A method for operating a combustion device with a combustion chamber, comprising:
conducting a gas flow into the combustion chamber from below through an orifice of a gas supply line arranged on a bottom side of the combustion chamber;
mixing the gas flow that flows in from the gas supply line with a gas rotating in the combustion chamber in a mixing region arranged in a region of the orifice;
conducting the gas flow tangentially from below and transversely to an axis against a first region of the combustion chamber, which first region is formed as a deflecting region of a gas flow and comprises a plurality of circular-segment-shaped cross-sections in parallel relationship to each other, with each circular-segment-shaped cross-section having a circular centre point, wherein a connection of the circular centre points substantially lies on the axis;
forming a side wall of the combustion chamber in the first region as part of a jacket surface of a rotational body, with the axis extending substantially along a rotational axis of the rotational body;
deflecting the gas flow in the first region about the axis, with the combustion chamber having in the a of the orifice of the gas supply line a second region with V-shaped cross-section tapering towards the orifice, with the mixing region being part of the second region;
forming a tangential flow against the first region along the side wall by arranging the second region tangentially adjacent to the first region; and
discharging the gas flow via an exhaust gas opening.

32. The method of claim 31, further comprising supplying burning material to the gas flow by a feeding device for the burning material.

33. The method of claim 31, further comprising supplying the gas flow with a tempering medium by a feeding device for the tempering medium, and discharging the tempering medium via the exhaust gas opening.
